(19) United States
(12) Patent Application Publication
(10) Pub. No.: US 2003/0174154 A1
(43) Pub. Date: Sep. 18, 2003

(54) User interface for interfacing with plural real-time data sources

(76) Inventors: Satoru Yukie, San Diego, CA (US); Gina C. Eubanks, San Diego, CA (US)

Correspondence Address: John L. Rogitz, Rogitz & Associates, 750 B. Street suite 3120, San Diego, CA, 92101, US

(21) Appl. No.: 09/542,154

(22) Filed: Apr. 4, 2000

(51) Int. Cl. G09G 5/00

(52) U.S. Cl. 345/700

(57) ABSTRACT

A system and method for monitoring real-time data customized data feeds such as are generated by in-home security cameras, telephones, appliances, as well as customized stock portfolios and other user-specific data, using a wireless terminal such as a PDA. The data feeds are communicated to the Internet by wired or wireless paths, and a server is connected to the Internet. A toolbar of customized sources is presented on the PDA, and a user can click on one of the toolbar icons to cause the server to establish a tunnel channel between the selected data source and the PDA, such that one or more of the selected real-time feeds from the respective data source can be viewed or otherwise displayed on the PDA.

### RELATED APPLICATIONS

This application claims priority from the following U.S. provisional applications, all filed Feb. 8, 2000: serial Nos. 60/181,129, 60/180,990, 60/180,987, 60/180,985, 60/181,148, 60/181,144, 60/181,145, 60/180,992, 60/180,991, 60/181,105, 60/181,128, 60/180,988, 60/181,147, 60/181,127, 60/180,984, 60/180,993, and from the following U.S. provisional applications: serial No. ______ (filed Mar. 22, 2000 under U.S. Express Mail label no. EL192413153US) and serial No. ______ (filed Mar. 27, 2000 under U.S. Express Mail label no. EL030392800US).

### BACKGROUND OF THE INVENTION

1. Field of the Invention

The present invention relates generally to monitoring multiple real-time data feeds from multiple customized sources using a remote terminal device.

2. Description of the Related Art

Personal computers and other personal computing devices such as personal digital assistants (PDAs) have become ubiquitous. Along with this, instant worldwide computer communication has become available via the Internet. This juxtaposition of technologies has spawned thousands of new computer-driven consumer devices that are convenient, useful, and indeed that quickly become indispensable.

One such consumer device is the personal digital assistant (PDA). Current PDAs enable users to carry a relatively large amount of data, such as checkbook data, telephone numbers, schedules, and the like in a small, user-friendly device. By manipulating the input device of a PDA a user can very quickly and conveniently access much information that the user might formerly have recorded in a number of different paper journals. In addition, PDAs provide much functionality usually associated with larger computers such as personal computers (PCs) and laptop computers. The present invention consequently recognizes that PDAs and other consumer computers potentially can support a large number of applications.

The present invention further recognizes that many additional useful applications can be supported using the Internet. Specifically, owing to the world wide computer-to-computer communications provided by the Internet, the present invention recognizes that many useful applications can be provided that use data gathered by or generated by other computers. Also, such applications, as understood herein, are not necessarily limited to simply using data, but can include two-way communication between computers to permit a first computer, such as a PC or PDA, to control or monitor a second computer, such as a digital telephone or a digital video camera, based on data communicated from the second computer to the first computer.

Unfortunately, in many cases network data transfer rates are relatively low. Most personal computers, for example, currently have Internet data transfer rates of less than 100 Kbps per second, making the communication of certain types of data, such as video, less than satisfactory over the Internet. Moreover, personal computers typically are connected to the Internet via telephone lines or fiber optic lines, meaning that the computers cannot be transported while connected to the Internet. Further, since the computers must be connected to hard-wired lines, cumbersome and costly line installation is required.

In the case of most wireless Internet network paths, the data rates are relatively slow, and moreover the network paths are not continuous. That is, to establish a wireless network path, a user has had to dial up the wireless network and establish a connection through a circuit switch. This renders impractical applications that require continuous, high data rate, wireless network paths. The present invention recognizes the above-noted problems and provides the solutions disclosed herein, as well as various applications that take advantage of these solutions.

### SUMMARY OF THE INVENTION

A user interface is disclosed with accompanying general purpose computer that is programmed according to the inventive steps herein. The invention can also be embodied as an article of manufacture—a machine component—that is used by a digital processing apparatus and which tangibly embodies a program of instructions that are executable by the digital processing apparatus to execute the present logic. This invention is realized in a critical machine component that causes a digital processing apparatus to perform the inventive method steps herein.

In one aspect the invention is a graphical user interface (GUI) for a user terminal including a monitor. The GUI includes a personalized toolbar that can be presented on the monitor and that has one or more icons. Each icon is associated with a respective network address of a respective source of digitized content in wireless communication with the terminal. A user can configure an icon to cause data from the respective source to be presented on the monitor.

In a preferred embodiment, the toolbar is defined by a user. At least some icons include thumbnails of data from the respective sources. Preferably, the toolbar is stored on a server and is associated with a user ID, such that the toolbar is presented on any computer device logged onto using the user ID and communicating with the server.

In another aspect, a computer system includes at least one user terminal including at least one output device, and plural sources of digitized content in wireless communication with the user terminal. Logic is executable by the terminal for displaying a toolbar on the output device. The toolbar includes one or more icons, each being associated with a respective source and each being manipulable by a computer input device associated with the terminal to select the associated source for display.

As envisioned by the preferred embodiment, each icon is associated with a content channel, and an icon is manipulable to cause data from the channel to be displayed. The preferred logic can receive an alert from at least one source and generate an alert signal in response thereto, with the alert signal altering the respective icon.

If desired, an icon can be enlarged when a user manipulates the icon. Data from a channel is displayed in the associated icon. Thus, the icon essentially functions as a display window.

In another aspect, a computer-implemented method for monitoring real-time customized data and stored public content includes providing a terminal accessing at least one wireless network path of a computer network, and providing one or more sources of data on the network. The method also includes displaying at least one channel selector element having multiple selections corresponding to the multiple sources to permit the user to select a source for display of data therefrom from among the sources of data.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram showing the system of the present invention;

FIG. 2 is a schematic diagram of a generic toolbar for use in selecting real-time data to be monitored;

FIG. 3 is a flow chart showing the overall logic of the invention;

FIG. 4 is a flow chart showing a more detailed logic flow;

FIG. 5 is a flow chart showing a specific logic flow when the real-time data includes, for example, video;

FIG. 6 is a flow chart showing further details of the user terminal logic;

FIG. 7 is a screen display of an implementation of the terminal toolbar and accompanying real-time data displays;

FIG. 8 is another screen display of an implementation of the terminal toolbar and accompanying real-time data displays; and

FIG. 9 is a flow chart showing terminal daemon logic.

### DETAILED DESCRIPTION OF THE PREFERRED EMBODIMENTS

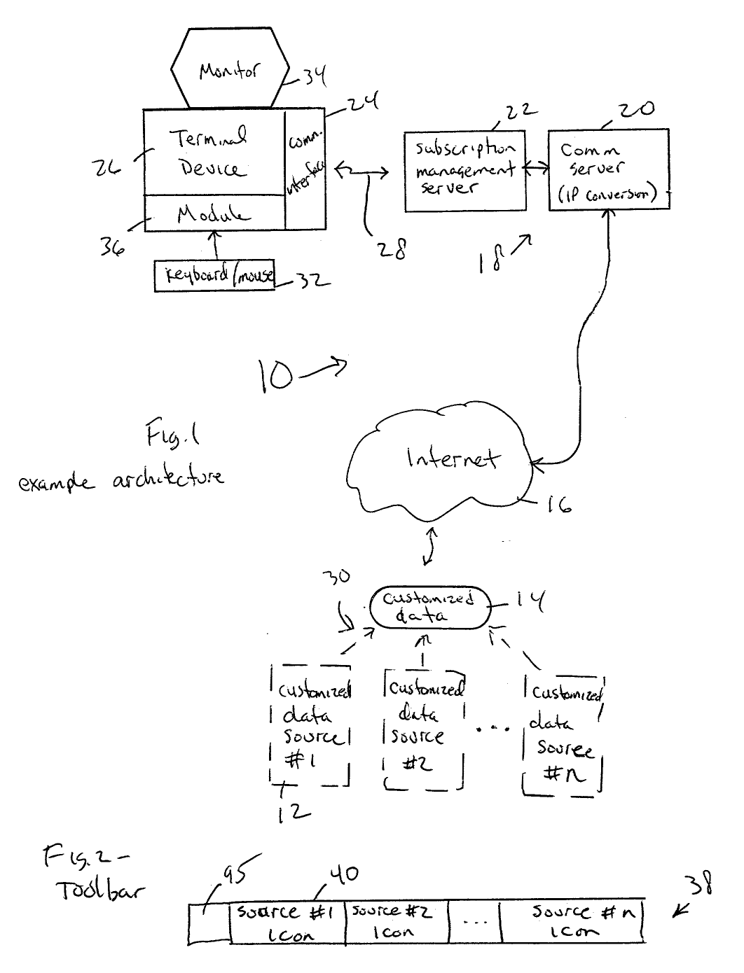

Referring initially to FIG. 1, a system is shown, generally designated 10, for selectively monitoring multiple real-time data feeds from one or more customized data sources 12, in addition to the publicly available sources mentioned further below. By “customized data sources” is meant sources that provide data as defined by the user or that are associated with the user, and not with the general public. For instance, one source 12 might be a home security camera or a video camera located in the user's child's playroom or day care center as defined (set up) by the user, while another source 12 might be the user's home telephone, either wired or wireless or both. Yet another source 12 might be a stock market feed with portions of its stock information compiled into customized user-defined portfolio. Still another source 12 might be an intra-office or inter-office intercom associated with the user or with a small group of people to which the user belongs, or an in-home appliance with, e.g., a JAVA interface. Another source 12 might be a customized database, such as, for example, an electronic journal of the user's personal finances, or a database containing customized public or third party content. The content can be stored on a server, such as a user's home video device or other device.

In the architecture shown, customized data 14 from the data sources 12 in Internet Protocol (IP) packets is sent via a network, such as but not limited to the Internet 16, to a server, generally designated 18. The server 18 can include a communication server 20 for appropriate format conversion to and from IP packets, and a service management server 22, both of which function to undertake the server logic includes in the flow charts below. If desired, the below-described server functions can be distributed among the sources 12/terminal 26.

In turn, data is communicated from the server 18 to a communication interface 24 of a terminal device 26. In accordance with present principles, the communication interface 24 can be a standard modem, in which case the network path 28 between the server 18 and terminal device 26 is a standard copper wire or optical fiber Internet path. In a preferred embodiment, however, the network path 28 is a wireless path such as the so-called iBurst™ or Ricochet™ communication systems, and more preferably is a space division multiple access (SDMA) path as disclosed in, e.g., U.S. Pat. Nos. 5,515,378, 5,592,490, 5,642,353, 5,828,658, and 5,909,471 to ArrayComm, incorporated herein by reference, in which case the communication interface 24 is an interface for undertaking appropriate conversion of PPP-formatted data from the server 18 to IP packet format (and to convert IP packet format data to PPP format for sending the data to the server 18). As set forth in the above-referenced patents, SDMA is essentially a directional version of time division multiple access (TDMA) or code division multiple access (CDMA), which produces a very high rate of data transmission (i.e., in excess of one megabyte per second) as compared to other types of Internet communication protocols. Likewise, the network paths 30 between the sources 12 and Internet 16 can be conventional wired Internet paths but more preferably are SDMA wireless paths.

The terminal device 26 is a digital processing apparatus, such as a personal digital assistant made by Sony. Or, the terminal device 26 can be a personal computer made by International Business Machines Corporation (IBM) or Apple computer, or the terminal device 26 may be any computer, including a laptop computer, a palmtop computer, or any other appropriate digital appliance.

As shown in FIG. 1, the terminal device 26 is electrically connected to one or more input devices 32, e.g., a mouse and/or a keyboard, which can be manipulated by a user of the system 10 as set forth further below to select customized data 14 from the sources 12 for display on, e.g., an output device such as a monitor 34. Other output devices such as other computers, computer networks, audio speakers, printers, and so on can be used.

As intended by the present invention, the terminal device 26 includes a daemon module 36. The flow charts herein illustrate the structure of the module 36 of the present invention as well as the logical structure of the server 18 and sources 12 as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer) to perform a sequence of function steps corresponding to those shown.

In other words, the present logic may be established as a computer program that is executed by a processor within, e.g., the terminal device 26 as a series of computer-executable instructions. In addition to residing on hard disk drives, these instructions may reside, for example, in RAM of the appropriate computer, or the instructions may be stored on a DASD array, magnetic tape, electronic read-only memory, or other appropriate data storage device. In an illustrative embodiment of the invention, the computer-executable instructions may be lines of compiled C⁺⁺ compatible code.

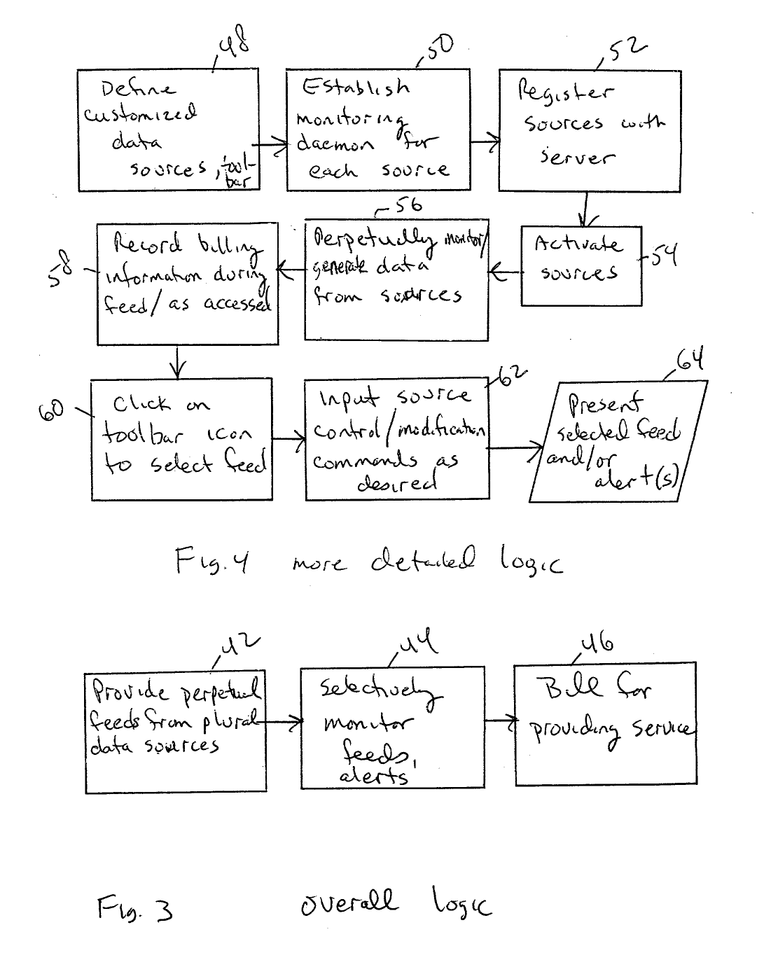

Now referring to FIG. 2, a generalized selector element 38 can be seen. In the preferred embodiment the selector element 38 is a toolbar, although other graphical user interface (GUI) elements can be used, such as, for example, drop-down menus. As shown, the selector element 38 includes plural source icons 40, with each icon 40 being associated with a respective one of the data sources 12 shown in FIG. 1. In associating an icon 40 with a source 12, it is to be understood that the icon can be associated with a hyperlink that points to the Internet protocol (IP) address or other address of the associated source 12. Details of a particularly preferred selector element are set forth below in reference to FIG. 8. An icon can be configured by the user to be static or it can display real-time data from its respective source. In the latter case, clicking on an icon can cause it to enlarge and/or to zoom in or expand the view.

In any case, the user establishes the data feeds he or she wants to monitor by appropriately defining the icons 40, in cooperation with the system server. Thus, the toolbar 38 is conformable. A user can specify the appearance, configuration, and content of the toolbar 38 depending on the available sources 12. The toolbar 38 can be further customized in light of the particular capabilities of the terminal 26. For example, text only icons might be established for a terminal 26 (e.g., a wireless telephone) that has limited display capabilities. Moreover, when the terminal 26 is an audio device, monitored data can be played and audible alerts generated when appropriate.

In any case, the selector element 38 is presented on the monitor 34 (FIG. 1) so that a user can click on one or more of the icons 40 to display on the monitor 34 the real-time data feed from the associated source 12. In addition or as an alternative, clicking on an icon can cause an option of services, e.g., in the form of a popup menu, to be displayed. These services can be tailored to the particular source. For example, the services can include, in the case of a home video camera, the ability to control the camera remotely.

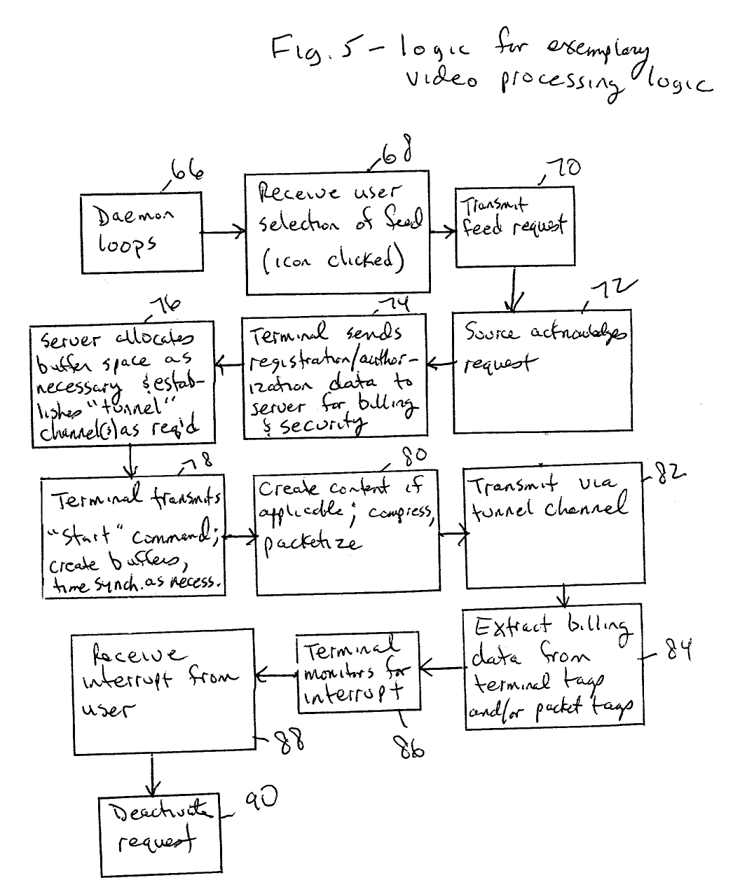

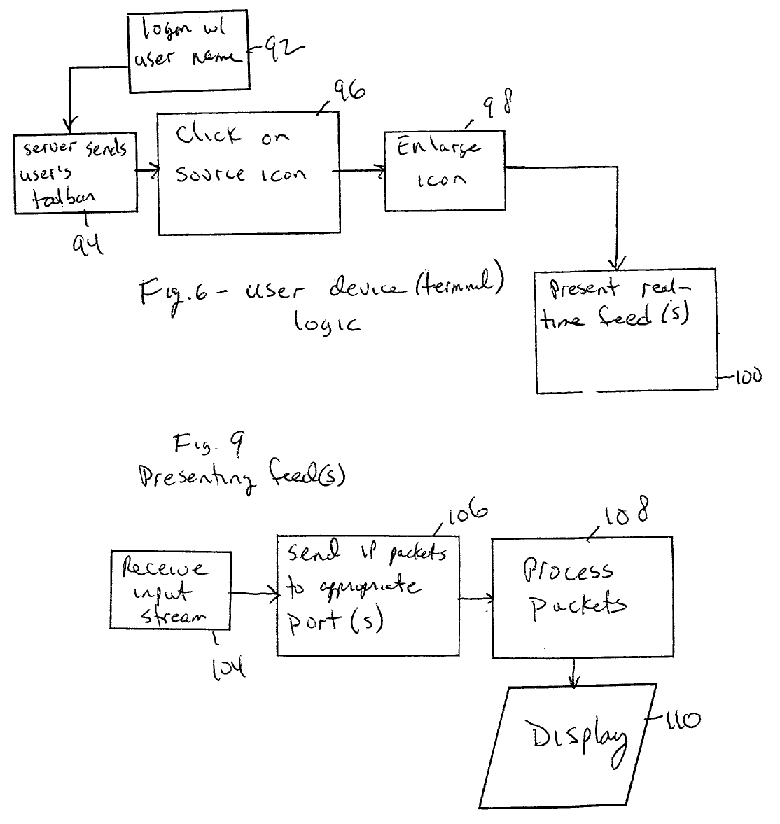

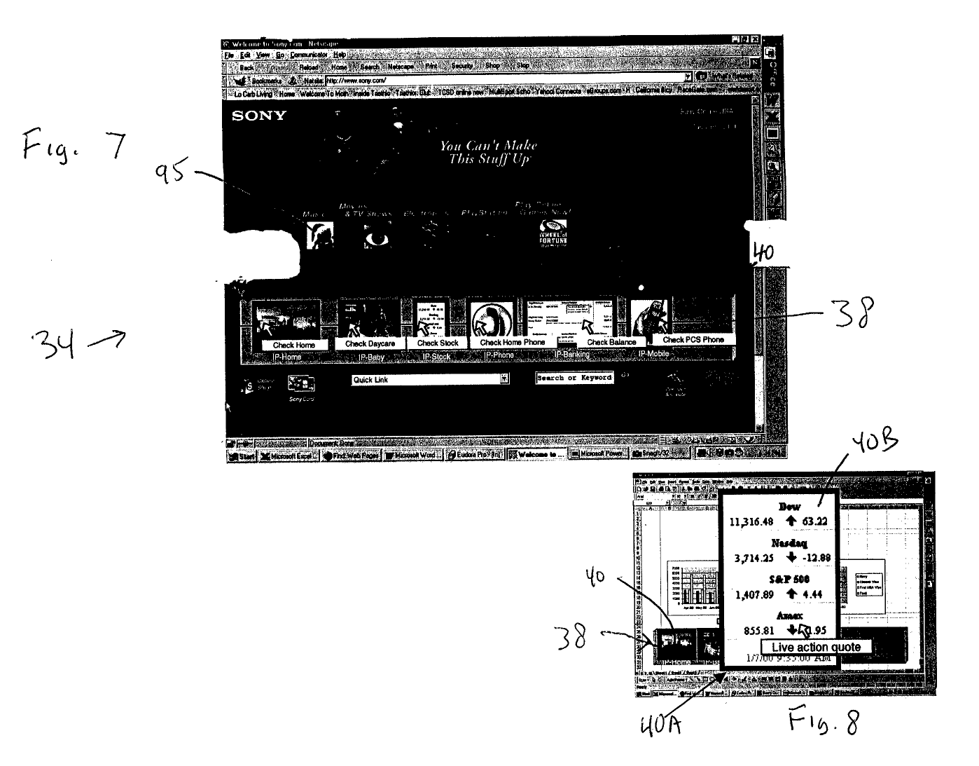

Referring now to FIG. 3, the overall logic can be seen. Commencing at block 42, perpetual, i.e., continuously available, data feeds, also referred to as data streams, are available from the data sources 12. As mentioned above, these feeds can be provided via wireless network path portions through the Internet. When a user is not monitoring a source, the data need not be transmitted from the sources 12 to the Internet, although it could be. Indeed, “continuously available” does not necessarily mean that the sources 12 actually continuously generate data, but that a source is continuously available to generate and send data real-time (i.e., within a few seconds) of receiving a request for it. In any case, the sources 12 are continuously available to generate data, preferably digitized data in Internet Protocol (IP) packet format.

At block 44, a user selectively monitors one or more data feeds from one or more sources 12. When an icon is static, clicking on the appropriate icon 40 (FIG. 2) causes the data feed to be displayed. When the icon is a window displaying real-time data, the user can view the relatively small icon or click on it to cause it to enlarge as described above, and/or to cause a menu of services related to the source 12 to appear

As discussed in greater detail below, selection of an icon is detected by the daemon module 36 at block 44, which communicates via the preferably wireless network path 28 with the server 18 to establish a preferably dedicated channel, referred to herein as a “tunnel channel”, between the selected source(s) and the terminal device 26. The selected data feeds are thereby communicated to the terminal device 26 for presentation thereof on the monitor 34, such that a user can monitor the feeds. Also, the user can monitor any alerts that might be generated by an unselected source 12, such as, for example, a stock price from a portfolio source, or a motion alarm from a security camera, or an incoming call alert from an in-home or cellular telephone. At block 46, the above-described service is billed for in accordance with accounting details set forth more fully below.

FIG. 4 shows additional details of the present logic. Commencing at block 48, the customized data sources 12 are defined by the user. For instance, the user can set up and start an in-home video camera at block 48, or define a list of stocks for inclusion in a stock portfolio maintained by an online quote service at block 48. Also, the toolbar 38 is defined, based on the sources 12. More specifically, icons 40 (with underlying source 12 addresses) of the toolbar 38 are established along with identifying the sources 12.

Moving to block 50, the daemon module 36 is established. In a preferred embodiment, a single daemon module 36 is provided for all the sources 12 as set forth further below, although each source 12 can have an associated module 36 at the terminal device 26.

Proceeding to block 52, the sources 12 are registered with the server 18. In the case of video cameras, telephones, and other Internet appliances, the registration includes recording the source's Internet protocol (IP) address or other identifying address with the server 18. The sources 12 are then activated at block 54.

Once activated, at block 56 the sources 12 are perpetually available to generate data streams that are available to, but that are not necessarily sent to, the terminal device 26 via the Internet. For instance, an in-home telephone might not continuously generate data and send it to the Internet unless the telephone receives an incoming call. Even if the telephone receives a call, digitized voice data might not be sent to the Internet unless and until the user at the terminal device 26 responds to an alert to answer the call by clicking on the appropriate icon 40 of the toolbar 38. Likewise, a video camera or other appliance is available to generate data continuously but might not generate the data until requested or, if continuously generating the data, might not send the data to the Internet until a user clicks on the appropriate icon of the toolbar 38. Regardless, both the telephone source 12 and video camera source 12 are continuously available to generate data in that they are both on and either generating data or continuously monitoring for a signal to generate data. In the case of a source 12 of quotes for a customized stock portfolio, the server 18 can be provided with real-time quotes for all publicly traded securities by a quote service, with the gathering of particular quotes into customized portfolios being accomplished at the server 18 for provision thereof to the user when the user clicks on the appropriate icon on the toolbar 38.

Billing for the above-described service can be accomplished at block 58. The billing is accomplished by gathering accounting data either during the entire time a source 12 or sources 12 are available via the Internet, or as the user displays the data from one or more sources 12 at block 60. That is, a user can be billed essentially a fixed monthly rate, and/or a user can be billed as the user actually displays the data streams from the sources 12. Invoices are periodically sent to the user of the terminal device 26 based on the accounting data gathered at block 58. Billing can also be done on a per-piece basis in the case of the below-described public sources, i.e., each time a user downloads a song or video. Also, a user can be billed on a service basis (the number and/or type of channels and/or monitoring services embodied in the toolbar 38) and on a registration basis (e.g., the number and/or type of terminal devices registered with the server, such as for customized download).

As shown at block 62, the user can periodically control the sources 12 (as by, for instance, answering a telephone call alert from a telephone source 12, or by modifying a stock portfolio). In any case, once a user selects a source 12 for display such as by clicking on the appropriate icon 40, the data is displayed at block 64. For instance, if the user clicks on an icon 40 representing a security video camera, the real-time video stream in IP packet format from the video camera source 12 is presented on the monitor 34 (FIG. 1).

FIG. 5 shows the details of one preferred but non-limiting implementation of the present logic for a single one of the sources 12, assuming that the source 12 is a source of digitized video data. Commencing at block 66, the daemon module 36 enters a loop. The loop can cause the daemon module to periodically “sleep” (e.g., for one-half second), and then “wake up” to poll the icons 40 to determine whether any icon 40 has been selected by the user in the past second. The daemon module thus can be a foreground or background process that continuously monitors for selection of a source 12 data stream to be displayed. Moreover, the daemon module 36 monitors the data feeds from the sources 12 when it “awakens”, to update the icons 40 as appropriate.

Assume that block 68 represents the selection of an icon 40 associated with a source 12 that is a video camera. Moving to block 70, the daemon transmits a feed request through the server 18 to the source 12 associated with the icon 40 that was clicked at block 68. At block 72, the source 12 acknowledges the request, and then a real-time video feed from the source 12 to the terminal 26 for display thereof is facilitated by several steps as follows. At block 74, the terminal 26 sends registration/authorization data tags to the server 18 for billing and security purposes. In response, at block 76 the server 18 allocates buffer space as required to buffer the video feed, authenticates the user, and registers the user for billing purposes. The server 18 can also allocate storage for the feed that can be later accessed if desired. Moreover, the server 18 preferably establishes a so-called “tunnel” channel, which is a private, secure, two-way dedicated channel between only the source 12 and terminal 26. When plural sources 12 are selected by the user, a single tunnel may be provided from the terminal 26 with plural threads, one for each source 12 feed.

While the server 18 is undertaking the above-described functions, the terminal 26 creates video buffers as necessary and undertakes time synchronization with the server 18 in accordance with video transmission principles known in the art. When the terminal 26 is ready to receive data, it sends a “start” command at block 78 to the source 12, which creates the requested content, compresses it, and packetizes it in IP packet format at block 80. The packets of data can include tags that, in addition to or in lieu of the terminal tags received at block 74, can be stripped or copied by the server 18 for billing purposes. Thus, billing can be undertaken on a per-transmitted packet basis (or based on multiple packets) if desired.

The source 12 undertakes time synchronization with the server 18, and a real-time video stream is transmitted via the wireless network paths and Internet described above at block 82. As it is transmitted, the packet tags can be extracted for billing purposes at block 84.

When the user no longer wishes to display the data from the source 12, the user can so indicate by, e.g., clicking once again on the icon 40 associated with the source 12 to essentially generate an interrupt signal. Accordingly, the terminal 26 monitors for an interrupt signal at block 86, and when one is generated, the terminal 26 sends the interrupt signal to the source 12 at block 88. The request for video is then deactivated at block 90, at which time data from the source 12 is no longer presented to the user.

FIGS. 6 and 7 show details of the structure and logic of the toolbar 38 shown in FIG. 2. Commencing at block 92, the user logs on using the appropriate user name and password to any suitable network device, such as the terminal device 26. When the user logs on, the server 18 correlates the user ID to the toolbar 38 defined at block 48 in FIG. 4 and sends the toolbar 38 to the user at block 94. Thus, the toolbar 38 is associated with a user, not necessarily with a particular network device, such that wherever the user logs on his or her own personalized toolbar is presented. The toolbar 38 is always displayed, although if desired the user can minimize the toolbar 38 and drag and drop the toolbar 38 on the display. The toolbar 38 can be resident on the terminal 26, with its configuration parameters being sent to the server for “portability” of the toolbar 38 to other devices that the user might log on to.

FIG. 7 shows that the icons 40 can be thumbnails generated by the respective source 12 to which they pertain. For example, the left-most icon shown in FIG. 7 is associated with an in-home video camera, and accordingly the icon is a thumbnail of an interior room. Likewise, an icon is shown that is associated with a day care video camera and that is a thumbnail of a day care center, while the next icon is associated with a customized stock portfolio and accordingly is a thumbnail of a personalized stock ticker. Other icons shown in FIG. 7 include a symbol of a telephone, associated with a network-attached telephone source 12, a check balance icon, associated with an online checkbook database, and a wireless telephone symbol, associated with an online wireless telephone. If desired, for icons representing video feeds, the icons themselves can be thumbnail videos of the real-time feeds, in which case the associated video source 12 would be continuously generating the feed and sending it via the network paths described above to the terminal 26. Or, still images from a video stream can be used for an icon. In any case, when an alert is received from a source, e.g., a networked telephone source 12, the terminal device 26 generates an alert signal. The alert signal can, for example, cause the associated icon 40 to blink, or to become highlighted. In addition or as an alternative an audible or even tactile alert can be generated, if desired, to indicate to the user that the user might want to access the source generating the alert.

In addition to customized data sources, FIG. 7 shows that the present display can present data from non-customized, i.e., publicly available, sources as well. Specifically, icons 95 representing, e.g., online music channels, online movies and television shows, online electronics vendors, and online games can be provided. Clicking on one of the icons 95 causes data from the associated public source to be displayed.

When the user wishes to display data or additional unshown data from a customized source 12, the user clicks on the appropriate icon 40 at block 96. At block 98 and now cross-referencing FIGS. 6 and 8, the clicked-on icon 40 can be enlarged, as shown at 40A in FIG. 8, to show the details of the icon 40. The exemplary icon 40 shown in FIG. 8 is a personalized portfolio stock quote, and so quotes 40B can be seen on the enlarged icon 40A. It will readily be appreciated that the enlarged icons 40A essentially are windows, and that when the user clicks on plural icons 40, plural enlarged icons 40A appear as windows on the display. It is to be further appreciated that in the case of a video source 12, clicking on the associated icon 40 causes an enlarged icon 40A to be displayed that is a video window. In any case, at block 100 the real-time feeds are presented, preferably in the windows established by the enlarged icons 40A.

FIG. 9 shows further details of how the daemon module 36 presents real-time feed. Commencing at block 104, the selected input stream or streams are received. At block 106 the IP packets of the streams are sent to the software port corresponding to the associated icon 40. That is, when more than one stream is being received, the packets of the various streams are separated from those of other streams and sent to the respective ports associated with the selected sources 12. The packets are processed in accordance with IP packet processing principles known in the art at block 108, and the processed data is then displayed at output state 110.

While the particular USER INTERFACE FOR INTERACTING WITH PLURAL REAL-TIME DATA SOURCES as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A graphical user interface (GUI) comprising:
a user terminal including a monitor;
a personalized toolbar presentable on the monitor and having at least one icon, each icon being associated with a respective network address of a respective source of digitized content in wireless communication with the terminal, whereby a user can configure an icon to cause data from the respective source to be presented on the monitor.

2. The GUI of claim 1, wherein the toolbar is defined by a user.

3. The GUI of claim 1, wherein at least one icon includes a thumbnail of data from the respective source.

4. The GUI of claim 1, wherein the toolbar is stored on a server and is associated with a user ID, such that the toolbar is presented on any computer device logged onto using the user ID and communicating with the server.

5. A computer system, comprising:
at least one user terminal including at least one output device;
one or more sources of digitized content in wireless communication with the user terminal; and
logic executable by the terminal for undertaking method acts comprising:
displaying a toolbar on the output device, the toolbar including one or more icons, each being associated with a respective source and each being configurable to present data from an associated source for display.

6. The system of claim 5, wherein at least one icon is established by a thumbnail of data from the respective source.

7. The system of claim 6, wherein each icon is associated with a content channel, an icon being manipulable to cause data from the channel to be displayed.

8. The system of claim 7, wherein the method acts undertaken by the logic further comprise receiving an alert from at least one source and generating an alert signal in response thereto, the alert signal altering the respective icon.

9. The system of claim 7, wherein an icon is enlarged when a user manipulates the icon.

10. The system of claim 7, wherein data from a channel is displayed in the associated icon.

11. The system of claim 6, wherein the toolbar is associated with a particular user, the toolbar being made available at the terminal in response to a user identification.

12. The computer system of claim 7, wherein the sources communicate with the terminal via a network path including the Internet.

13. The computer system of claim 12, wherein at least a portion of the network path is a directional wireless path.

14. The computer system of claim 7, wherein at least one source is a customized data source.

15. The computer system of claim 7, wherein at least one source is a source of digitized public content.

16. The computer system of claim 7, wherein the logic is embodied by a daemon that loops in a monitoring state to determine at least one of: whether the user has manipulated an icon, and whether new data has been sent from a source.

17. A computer-implemented method for monitoring real-time customized data and stored public content data, comprising the acts of:
providing a terminal accessing at least one wireless network path of a computer network;
providing at least one source of data on the network; and
displaying at least one channel selector element having at least one selection corresponding to the source to permit the user to select a source for display of data therefrom.

18. The method of claim 17, wherein the selector element is a toolbar having at least one icon, each icon being associated with a respective selection.

19. The method of claim 18, wherein at least one icon is established by thumbnails of data from the respective sources.

20. The method of claim 18, wherein each icon is associated with a content channel, an icon being manipulable to cause data from the channel to be displayed.

21. The method of claim 18, further comprising receiving an alert from at least one source and generating an alert signal in response thereto, the alert signal altering the respective icon.

22. The method of claim 18, wherein an icon is enlarged when a user manipulates the icon.

23. The method of claim 18, wherein the toolbar is associated with a particular user, the toolbar being made available at the terminal in response to a user identification.

24. The method of claim 18, wherein the sources communicate with the terminal via a network path including the Internet.

25. The method of claim 24, wherein at least a portion of the network path is a directional wireless path.

26. The method of claim 18, wherein at least one source is a customized data source and at least one source is a source of digitized public content.

27. The system of claim 5, wherein at least one icon is established by text from the respective source.

28. The GUI of claim 1, wherein at least one icon is established by text from the respective source.

29. The system of claim 8, wherein the alert is an audible alert.

30. The system of claim 1, wherein the method acts undertaken by the logic further include presenting an option of services in response to manipulating an icon.

31. The system of claim 5, wherein the method acts undertaken by the logic further include presenting an option of services in response to manipulating an icon.

32. The method of claim 17, further including presenting an option of services in response to making a selection.
